(19) United States
(12) Patent Application Publication
(10) Pub. No.: US 2009/0256102 A1
(43) Pub. Date: Oct. 15, 2009

(54) FLUOROPOLYMER AND SOIL REMOVER

(75) Inventor: Norimasa Uesugi, Osaka (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD., Osaka-shi, Osaka (JP)

(21) Appl. No.: 11/995,225

(22) PCT Filed: Jul. 11, 2006
(86) PCT No.: PCT/JP2006/313753

§ 371 Date: Jun. 12, 2008

(30) Foreign Application Priority Data
Jul. 14, 2005 (JP) 2005-205228

(51) Int. Cl. D06M 15/263; C08F 214/18

(52) U.S. Cl. 252/8.62; 526/243

(57) ABSTRACT

A fluorocopolymer formed from, as essential ingredients,
(a) a fluoromonomer represented by the general formula:

CH₂═C(—X)—C(—O)—Y—[—(CH₂)ₘ-Z-]ₚ-(CH₂)ₙ—Rf (1)
[wherein X is hydrogen, C₁₋₂₁ linear or branched alkyl, fluorine, chlorine, bromine, iodine, —CFX¹X² (wherein X¹ and X² each is hydrogen, fluorine, chlorine, bromine, or iodine), cyano, C₁₋₂₁ linear or branched fluoroalkyl, (un)substituted benzyl, or (un)substituted phenyl; Y is —O— or —NH—; Z is —S— or —SO₂—; Rf is C₁₋₂₁ fluoroalkyl; m is 1-10; n is 0-10; and p is 0 or 1] and
(b) a polyalkylene glycol (meth)acrylate. A soil remover containing this fluorocopolymer imparts to a woven fabric, etc. excellent oil repellency, unsusceptibility to fouling, and the property of releasing stains therefrom, while maintaining durability in washing.

### TECHNICAL FIELD

The present invention relates to a fluorine-containing copolymer which imparts excellent oil repellency, stain-proofing properties and soil releasability to a treated article such as a textile, and is also excellent in washing-durability of oil repellency, stain-proofing properties and soil releasability.

### BACKGROUND ART

As a stain-proofing agent which imparts water- and oil-repellency to fiber woven fabrics and the like, and also enables easy removal of stains adhered on fibers through washing, a copolymer of a (meth)acrylate ester having a fluoroalkyl group (hereinafter also referred to as a fluorine-containing compound) and a hydrophilic group-containing compound is known (cf. JP-A-53-134786, JP-A-59-204980 and JP-A-62-7782).

However, fiber woven fabrics and the like treated with these fluorine-containing copolymers do not always have satisfactory washing durability and also have a tendency of failing to have sufficient and satisfactory soil releasability against persistent soils (for example, waste oil such as used engine oil).

It is considered that oil repellency and flip-flop properties are important so as to obtain sufficient soil releasability and, in air, perfluoroalkyl groups (hereinafter abbreviated to Rf groups) are oriented on the surface so that high oil repellency is exhibited. In contrast, in water, Rf groups retract and hydrophilic groups are oriented on the surface, and thus soils are easily removed. Flip-flop properties are properties that a surface molecular structure varies depending on the environment in air and water, and are proposed by Sherman et al. [P. Sherman, S. Smith, B, Johannessen, Textile Research Journal, 39, 499 (1969)]

When the Rf group has a short chain length, oil repellency tends to deteriorate as crystallinity of Rf decreases and an article to be treated is easily contaminated with oil soils. Therefore, a stain-proofing agent having Rf group containing at least 8 carbon atoms has been substantially used (cf. JP-A-53-134786 and JP-A-2000-290640).

Recently, as to compounds containing Rf group having 8 carbon atoms which are prepared by telomerization, the Federal Register (FR Vol. 68, No. 73/Apr. 16, 2003 [FRL-2303-8]) (http://www.epa.gov/opptintr/pfoa/pfoafr.pdf), EPA Environmental News for release Monday April, 2003 “EPA INTENSIFIES SCIENTIFIC INVESTIGATION OF A CHEMICAL PROCESSING AID” (http://www.epa.gov/opptintr/pfoa/pfoaprs.pdf), and EPA OPPT FACT SHEET Apr. 14, 2003 (http://www.epa.gov/opptintr/pfoa/pfoafacts.pdf) announced that a “telomer” may possibly metabolize or decompose to PFOA.

EPA (Environmental Protection Agency of USA) announced on Apr. 14, 2003 that the EPA intensifies the scientific investigation on PFOA (cf. EPA Report “PRELIMINARY RISK ASSESSMENT OF THE DEVELOPMENTAL TOXICITY ASSOCIATED WITH EXPOSURE TO PERFLUOROOCTANOIC ACID AND ITS SALTS” (http://www.epa.gov/opptintr/pfoa/pfoara.pdf)).

### DISCLOSURE OF THE INVENTION

An object of the present invention is to provide a soil release agent which imparts excellent oil repellency, stain-proofing properties and soil releasability to fiber woven fabrics and the like while maintaining washing durability, and also provides a soil release agent which is similarly excellent even if the number of carbon atoms of an Rf group is decreased to less than 8, which is less than that in the prior art.

The present invention provides a fluorine-containing copolymer comprising repeating units derived from:

(a) a fluorine-containing monomer represented by the general formula:

CH₂═C(—X)—C(═O)—Y—[—(CH₂)ₘ-Z-]ₚ-(CH₂)ₙ—Rf (1)

wherein X is a hydrogen atom, a linear or branched alkyl group having 1 to 21 carbon atoms, a fluorine atom, a chlorine atom, a bromine atom, a iodine atom, a CFX¹X² group (wherein X¹ and X² represent a hydrogen atom, a fluorine atom, a chlorine atom, a bromine atom, or a iodine atom), a cyano group, a linear or branched fluoroalkyl group having 1 to 21 carbon atoms, a substituted or an unsubstituted benzyl group, or a substituted or an unsubstituted phenyl group;

### Y is —O— or —NH—;

### Z is —S— or —SO₂—;

Rf is a fluoroalkyl group having 1 to 21, particularly 1 to 6 carbon atoms;
m is 1 to 10, n is 0 to 10, and p is 0 or 1; and

(b) a polyalkylene glycol (meth)acrylate.

The fluorine-containing copolymer of the present invention works as an active component of a soil release agent.

### EFFECT OF THE INVENTION

According to the present invention, a fluorine-containing copolymer constituting a soil release agent, which imparts excellent oil repellency, stain-proofing properties and soil releasability to textiles and is also excellent in washing durability, is obtained.

Also, a similarly excellent above-mentioned soil release agent is obtained even if the number of carbon atoms of a perfluoroalkyl group in the fluorine-containing copolymer is less than 8.

In the prior art, when the Rf group has less than 8 carbon atoms, soil releasability deteriorates. According to the present invention, by using a polymerizable monomer with an Rf group having less than 8 carbon atoms, high flip-flop properties and oil repellency in air are maintained and excellent soil releasability is obtained.

### MODE FOR CARRYING OUT THE INVENTION

The fluorine-containing copolymer of the present invention is a fluorine-containing copolymer comprising (A) the repeating unit derived from a fluorine monomer (a) and (B) the repeating unit derived from a polyalkylene glycol (meth)acrylate (b).

If necessary, the fluorine-containing copolymer may have (C) a repeating unit derived from a monomer other than the monomers (a) and (b), which has an unsaturated double bond capable of copolymerizing with the monomers (a) and (b).

In the present invention, the repeating unit (A) is composed of the fluorine-containing monomer (a) of the formula (1).

The fluorine-containing monomer (a) may be substituted with a halogen atom or the like at the α-position (of acrylate or methacrylate). Therefore, in the formula (1), X may be a linear or branched alkyl group having 2 to 21 carbon atoms, a fluorine atom, a chlorine atom, a bromine atom, a iodine atom, a CFX¹X² group (wherein X¹ and X² represent a hydrogen atom, a fluorine atom, a chlorine atom, a bromine atom or a iodine atom), a cyano group, a linear or branched fluoroalkyl group having 1 to 21 carbon atoms, a substituted or an unsubstituted benzyl group, or a substituted or an unsubstituted phenyl group.

In the formula (1), the Rf group is preferably a perfluoroalkyl group. The number of carbon atoms of the Rf group is from 1 to 6, for example, 1 to 5, and particularly from 1 to 4. Examples of the Rf group include —CF₃, —CF₂CF₃, —CF₂CF₂CF₃, —CF(CF₃)₂, —CF₂CF₂CF₂CF₃, —CF₂CF(CF₃)₂, —C(CF₃)₃, —(CF₂)₄CF₃, —(CF₂)₂CF(CF₃)₂, —CF₂C(CF₃)₃, —CF(CF₃)CF₂CF₂CF₃, —(CF₂)₅ CF₃, —(CF₂)₃CF(CF₃)₂, —(CF₂)₄CF (CF₃)₂, —(CF₂)₇CF₃, —(CF₂)₅CF(CF₃)₂, —(CF₂)₆CF(CF₃)₂, and —(CF₂)₉CF₃.

“m” may be, for example, from 2 to 10, and “n” may be, for example, from 1 to 10.

Preferably, “p” is 1 when Y is —O—, and is 0 when Y is —NH—.

Examples of the fluorine-containing monomer (a) include the following:
CH₂═C(—X)—C(═O)—O—(CH₂)ₘ—S—(CH₂)ₙ—Rf,
CH₂═C(—X)—C(═O)—O—(CH₂)ₘ—SO₂—(CH₂)ₙ—Rf, and
CH₂═C(—X)—C(═O)—NH—(CH₂)—Rf
   wherein X is a hydrogen atom, a linear or branched alkyl group having 1 to 21 carbon atoms, a fluorine atom, a chlorine atom, a bromine atom, a iodine atom, a CFX¹X² group (wherein X¹ and X² represent a hydrogen atom, a fluorine atom or a chlorine atom), a cyano group, a linear or branched fluoroalkyl group having 1 to 21 carbon atoms, a substituted or an unsubstituted benzyl group, or a substituted or an unsubstituted phenyl group;

Rf is a fluoroalkyl group having 1 to 21, particularly 1 to 6 carbon atoms; and

m is from 1 to 10, and n is from 0 to 10.

Particularly, general formula (2):

CH₂═C(X)—C(═O)—O—(CH₂)ₘ—SO₂(CH₂)ₙ—Rf

is preferred.

Specific examples of the fluorine-containing monomer (a) include, but are not limited to, the following:
CH₂═C(—H)—C(═O)—O—(CH₂)₂—S—Rf,
CH₂═C(—H)—C(═O)—O—(CH₂)₂—S—(CH₂)₂—Rf,
CH₂═C(—H)—C(═O)—C—(CH₂)₃—SO₂—Rf,
CH₂═C(—H)—C(═O)—O— (CH₂)₂—SO₂—(CH₂)₂—Rf,
CH₂═C(—H)—C(═O)—NH— (CH₂)₂—Rf,
CH₂═C(—CH₃)—C(═O)—O—(CH₂)₂—S—Rf,
CH₂═C(—CH₃)—C(═O)—O— (CH₂)₂—S—(CH₂)₂—Rf,
CH₂═C(—CH₃)—C(═O)—O—(CH₂)₃—SO₂—Rf,
CH₂═C(—CH₃)—C(═O)—C—(CH₂)₂—SO₂—(CH₂)₂—Rf,
CH₂═C(—CH₃)—C(═O)—NH—(CH₂)₂—Rf,
CH₂═C(—F)—C(═O)—O—(CH₂)₂—S—Rf,
CH₂═C(—F)—C(═O)—O—(CH₂)₂—S—(CH₂)₂—Rf,
CH₂═C(—F)—C(═O)—C—(CH₂)₂—SO₂—Rf,
CH₂═C(—F)—C(═O)—C—(CH₂)₂—SO₂—(CH₂)₂—Rf,
CH₂═C(—F)—C(═O)—NH—(CH₂)₂—Rf,
CH₂═C(—Cl)—C(═O)—C—(CH₂)₂—S—Rf,
CH₂═C(—Cl)—C(═O)—C—(CH₂)₂—S—(CH₂)₂—Rf,
CH₂═C(—Cl)—C(═O)—C—(CH₂)₂—SO₂—Rf,
CH₂═C(—Cl)—C(═O)—C—(CH₂)₂—SO₂—(CH₂)₂—Rf,
CH₂═C(—Cl)—C(═O)—NH—(CH₂)₂—Rf,
CH₂═C(—CF₃)—C(═O)—O—(CH₂)₂—S—Rf,
CH₂═C(—CF₃)—C(═O)—O— (CH₂)₂—S—(CH₂)₂—Rf,
CH₂═C(—CF₃)—C(═O)—O— (CH₂)₂—SO₂—Rf,
CH₂═C(—CF₃)—C(═O)—O—(CH₂)₂—SO₂—(CH₂)₂—Rf,
CH₂═C(—CF₃)—C(═O)—NH—(CH₂)₂—Rf,
CH₂═C(—CF₂H)—C(═O)—O—(CH₂)₂—S—Rf,
CH₂═C(—CF₂H)—C(═O)—C—(CH₂)₂—S—(CH₂)₂—Rf,
CH₂═C(—CF₂H)—C(═O)—O—(CH₂)₂—SO₂—Rf,
CH₂═C(—CF₂H)—C(═O)—O—(CH₂)₂—SO₂—(CH₂)₂—Rf,
CH₂═C(—CF₂H)—C(═O)—NH—(CH₂)₂—Rf,
CH₂═C(—CN)—C(═O)—O—(CH₂)₂—S—Rf,
CH₂═C(—CN)—C(═O)—C—(CH₂)₂—S—(CH₂)₂—Rf,
CH₂═C(—CN)—C(═O)—O—(CH₂)₂—SO₂—Rf,
CH₂═C(—CN)—C(═O)—O—(CH₂)₂—SO₂—(CH₂)₂—Rf,
CH₂═C(—CN)—C(═O)—NH—(CH₂)₂—Rf,
CH₂═C(—CF₂CF₃)—C(═O)—C—(CH₂)₂—S—Rf,
CH₂═C(—CF₂CF₃)—C(═O)—O—(CH₂)₂—S—(CH₂)₂—Rf,
CH₂═C(—CF₂CF₃)—C(═O)—O—(CH₂)₂—SO₂—Rf,
CH₂═C(—CF₂CF₃)—C(═O)—O—(CH₂)₂—SO₂—(CH₂)₂—Rf,
CH₂═C(—CF₂CF₃)—C(═O)—NH—(CH₂)₂—Rf,
CH₂═C(—F)—C(═O)—O—(CH₂)₃—S—Rf,
CH₂═C(—F)—C(═O)—O—(CH₂)₃—S—(CH₂)₂—Rf,
CH₂═C(—F)—C(═O)—O—(CH₂)₃—SO₂—Rf,
CH₂═C(—F)—C(═O)—O— (CH₂)₃—SO₂— (CH₂)₂—Rf,
CH₂═C(—F)—C(═O)—NH— (CH₂)₃—Rf,
CH₂═C(—Cl)—C(═O)—O—(CH₂)₃—S—Rf,
CH₂═C(—Cl)—C(═O)—O—(CH₂)₃—S—(CH₂)₂—Rf,
CH₂═C(—Cl)—C(═O)—O—(CH₂)₃—SO₂—Rf,
CH₂═C(—Cl)—C(═O)—O—(CH₂)₃—SO₂—(CH₂)₂—Rf,
CH₂═C(—CF₃)—C(═O)—O—(CH₂)₃—S—Rf,
CH₂═C(—CF₃)—C(═O)—O— (CH₂)₃—S—(CH₂)₂—Rf,
CH₂═C(—CF₃)—C(═O)—O—(CH₂)₃—SO₂—Rf,
CH₂═C(—CF₃)—C(═O)—O— (CH₂)₃—SO₂—(CH₂)₂—Rf,
CH₂═C(—CF₂H)—C(═O)—O—(CH₂)₃—S—Rf,
CH₂═C(—CF₂H)—C(═O)—O— (CH₂)₃—S—(CH₂)₂—Rf,
CH₂═C(—CF₂H)—C(═O)—O—(CH₂)₃—SO₂—Rf,
CH₂═C(—CF₂H)—C(═O)—O—(CH₂)₃—SO₂—(CH₂)₂—Rf,
CH₂═C(—CN)—C(═O)—O—(CH₂)₃—S—Rf,
CH₂═C(—CN)—C(═O)—O—(CH₂)₃—S—(CH₂)₂—Rf,
CH₂═C(—CN)—C(═O)—O—(CH₂)₃—SO₂—Rf,
CH₂═C(—CN)—C(═O)—O—(CH₂)₃—SO₂—(CH₂)₂—Rf,
CH₂═C(—CF₂CF₃)—C(═O)—O—(CH₂)₃—S—Rf,
CH₂═C(—CF₂CF₃)—C(═O)—O—(CH₂)₃—S—(CH₂)₂—Rf,
CH₂═C(—CF₂CF₃)—C(═O)—O—(CH₂)₃—SO₂—Rf, and
CH₂═C(—CF₂ CF₃)—C(═O)—C—(CH₂)₂—SO₂—(CH₂)₂—Rf,
   wherein Rf is a fluoroalkyl group having 1 to 21, particularly 1 to 6 carbon atoms.

The component (a) may be a mixture of at least two types.

The component (b) may be a polyalkylene glycol mono(meth)acrylate and/or a polyalkylene glycol di(meth)acrylate. The molecular weight of the component (b) may be 500 or more, for example, 1,000 or more, and particularly 1,500 or more. The upper limit of the molecular weight of the component (b) may be 200,000, and particularly 20,000.

The polyalkylene glycol mono(meth)acrylate and polyalkylene glycol di(meth)acrylate are preferably represented by the general formulas:

CH₂═CX¹C(═O)—O—(RO)—X² (3a)

and

CH₂═CX¹C(═O)—O—(RO)ₙ—C(═O)CX¹═CH₂ (3b)

wherein
X¹ is a hydrogen atom or a methyl group,
X² is a hydrogen atom or an unsaturated or saturated hydrocarbon group having 1 to 22 carbon atoms,
R is an alkylene group having 2 to 6 carbon atoms, and
n is an integer of 2 to 90. “n” may be particularly from 2 to 30, for example, 2 to 20.

In the component (b), R in general formulas (3a) and (3b) is particularly preferably an ethylene group.

In the component (b), R in general formulas (3a) and (3b) may be a combination of at least two types of alkylene groups. In this case, at least one R is preferably an ethylene group. Examples of the combination of R include a combination of an ethylene group/a propylene group and a combination of an ethylene group/a butylene group.

The component (b) may be a mixture of at least two types. In this case, the component (b) is preferably a mixture in which at least one R in general formulas (3a) and (3b) is an ethylene group.

Specific examples of the component (b) include, but are not limited to, the following:
CH₂═CHCOO—(CH₂ CH₂O)₉—H,
CH₂═C(CH₃)COO—(CH₂CH₂O)₉—H,
CH₂═C(CH₃)COO—(CH₂CH₂O)₅—CH₃,
CH₂═C(CH₃)COO—(CH₂CH₂O)₉—CH₃,
CH₂═C(CH₃)COO—(CH₂CH₂O)₂₃—CH₃,
CH₂═C(CH₃)COO—(CH₂CH₂O)₉₀—CH₃,
CH₂═C(CH₃)COO—(CH₂CH(CH₃)O)₉—H
CH₂═CHCOO—(CH₂CH(CH₃)O)₉—H,
CH₂═C(CH₃)COO—(CH₂CH(CH₃)O)₉—CH₃,
CH₂═C(CH₃)COO—(CH₂CH(CH₃)O)₁₂—CH₃,
CH₂═C(CH₃)COO—(CH₂CH₂O)₅—(CH₂CH(CH₃)O)₂—H,
CH₂═C(CH₃)COO—(CH₂CH₂O)₅—(CH₂CH(CH₃)O)₃—CH₃,
CH₂═C(CH₃)COO—(CH₂CH₂O)₈—(CH₂CH(CH₃)O)₆—CH₂CH(C₂H₅)C₄H₉,
CH₂═C(CH₃)COO— (CH₂ CH₂O)₂₃—OOC(CH₃)C═CH₂, and
CH₂═C(CH₃)COO—(CH₂CH₂O)₂₀—(CH₂CH(CH₃)O)₅—CH₂—CH═CH₂.

In the fluorine-containing copolymer of the present invention, the amount of the component (a) may be from 20 to 90% by weight, and preferably from 30 to 85% by weight, based on the total of the component (a) and the component (b). The lower limit of the component (a) may be, for example, 35% by weight, and particularly 50% by weight. When the amount is from 20% to 90% by weight, high soil releasability can be attained and also intrusion of oil stains can be prevented.

The amount of the component (b) may be from 10 to 80% by weight, and preferably from 15 to 70% by weight, based on the total of the component (a) and the component (b). The upper limit of the amount of the component (b) may be, for example, 65% by weight, and particularly 50% by weight.

For the purpose of an improvement in durable soil releasability, solubility in an organic solvent, flexibility and adhesion to a treated article, another polymerizable monomer [a component (c)], particularly a non-fluorine monomer may be introduced into the fluorine-containing copolymer of the present invention.

Specific examples of the component (c) include, but are not limited to, diacetoneacrylamide, (meth)acrylamide, N-methylolacrylamide, hydroxyethyl (meth)acrylate, 3-chloro-2-hydroxypropyl (meth)acrylate, N,N-dimethylaminoethyl (meth)acrylate, N,N-diethylaminoethyl (meth)acrylate, butadiene, chloroprene, glycidyl (meth)acrylate, a maleic acid derivative, a vinyl halide such as vinyl chloride, ethylene, a vinylidene halide such as vinylidene chloride, a vinyl alkyl ether, glycerol (meth)acrylate, styrene, acetoacetoxyethyl (meth)acrylate, an alkyl (meth)acrylate, vinylpyrrolidone, and an isocyanate group-containing (meth)acrylate such as 2-isocyanate ethyl methacrylate or said (meth)acrylate in which an isocyanate group is blocked with a blocking agent such as methyl ethyl ketoxime.

The copolymerization proportion of the component (c) may be from 0 to 40% by weight, and preferably from 0 to 30% by weight, for example, 0.1 to 20% by weight, based on the fluorine-containing copolymer. The component (c) may be a mixture of at least two types.

The weight-average molecular weight of the fluorine-containing copolymer of the present invention may be from 1,000 to 1,000,000, and preferably from 5,000 to 500,000. When the weight-average molecular weight is from 1,000 to 1,000,000, high soil releasability is obtained while maintaining durability and a polymer liquid has low viscosity so that it is easy to handle. The molecular weight is determined by using gel permeation chromatography, in terms of polystyrene.

The copolymer of the present invention may be a random copolymer or a block copolymer.

A polymerization method of producing the copolymer of the present invention is not limited. Various polymerization methods such as a bulk polymerization, a solution polymerization, an emulsion polymerization and a radiation polymerization can be selected. For example, a solution polymerization using an organic solvent and an emulsion polymerization using water or both an organic solvent and water are generally selected. A treatment liquid is produced by diluting a reaction mixture with water or adding an emulsifying agent to make the emulsification after the polymerization.

Examples of the organic solvent include ketones such as acetone and methyl ethyl ketone; esters such as ethyl acetate and methyl acetate; glycols such as propylene glycol, dipropylene glycol monomethyl ether, dipropylene glycol, tripropylene glycol and low molecular weight polyethylene glycol; and alcohols such as ethyl alcohol and isopropanol.

As the emulsifying agent for the emulsion polymerization and for emulsification in water by adding the emulsifying agent after polymerization, various conventional emulsifying agents such as an anionic emulsifying agent, a cationic emulsifying agent and a nonionic emulsifying agent can be used.

As the polymerization initiator, for example, peroxide, an azo compound or a persulfuric acid-based compound can be used. The polymerization initiator is generally water-soluble and/or oil-soluble.

Specific examples of the oil-soluble polymerization initiator are preferably 2,2′-azobis(2-methylpropionitrile), 2,2′-azobis(2-methylbutyronitrile), 2,2′-azobis(2,4-dimethylvaleronitrile), 2,2′-azobis(2,4-dimethyl-4-methoxyvaleronitrile), 1,1′-azobis(cyclohexane-1-carbonitrile), dimethyl 2,2′-azobis(2-methylpropionate), 2,2′-azobis(2-isobutyronitrile), benzoyl peroxide, di-tertiary-butyl peroxide, lauryl peroxide, cumene hydroperoxide, t-butyl peroxypivalate, diisopropyl peroxydicarbonate, and t-butyl perpivalate.

Specific examples of the water-soluble polymerization initiator are preferably 2,2′-azobisisobutylamidine dihydrochloride, 2,2′-azobis(2-methylpropionamidine) hydrochloride, 2,2′-azobis[2-(2-imidazolin-2-yl)propane]hydrochloride, 2,2′-azobis[2-(2-imidazolin-2-yl)propane]sulfate hydrate, 2,2′-azobis[2-(5-methyl-2-imidazolin-2-yl)propane]hydrochloride, potassium persulfate, barium persulfate, ammonium persulfate, and hydrogen peroxide.

The polymerization initiator is used in an amount within a range from 0.01 to 5 parts by weight based on 100 parts by weight of the monomer.

For the purpose of adjusting the molecular weight, a known mercapto group-containing compound may be used. Specific examples thereof include 2-mercaptoethanol, thiopropionic acid, and alkyl mercaptan. The mercapto group-containing compound may used in an amount of 5 parts by weight or less, within a range from 0.01 to 3 parts by weight, based on 100 parts by weight of the monomer.

Specifically, a copolymer can be produced in the following manner.

In a solution polymerization, it is possible to employ a method of dissolving a monomer in an organic solvent in the presence of a polymerization initiator, replacing the atmosphere by nitrogen and stirring the solution with heating at a temperature within a range from 50 to 120° C. for 1 to 10 hours. The polymerization initiator generally may be an oil-soluble polymerization initiator. The organic solvent is inert to the monomer and dissolves it, and examples of the organic solvent include pentane, hexane, heptane, octane, cyclohexane, benzene, toluene, xylene, petroleum ether, tetrahydrofuran, 1,4-dioxane, methyl ethyl ketone, methyl isobutyl ketone, ethyl acetate, butyl acetate, 1,1,2,2-tetrachloroethane, 1,1,1-trichloroethane, trichloroethylene, perchloroethylene, tetrachlorodifluoroethane, and trichlorotrifluoroethane. The organic solvent may be used in an amount within a range from 50 to 1,000 parts by weight based on 100 parts by weight of the total of the monomer.

In an emulsion polymerization, there can be used a method of emulsifying monomers in water in the presence of a polymerization initiator and an emulsifying agent, replacing the atmosphere by nitrogen, and polymerizing with stirring, for example, at the temperature within the range from 50° C. to 80° C. for 1 hour to 10 hours. The polymerization initiator may be the water-soluble polymerization initiator and/or the oil-soluble polymerization initiator.

In order to obtain a polymer dispersion in water, which is superior in storage stability, it is desirable that the monomers are dispersed in water by using an emulsifying device capable of applying a strong shearing energy (e.g., a high-pressure homogenizer and an ultrasonic homogenizer) and then polymerized with using the water-soluble polymerization initiator. As the emulsifying agent, various emulsifying agents such as an anionic emulsifying agent, a cationic emulsifying agent and a nonionic emulsifying agent can be used in the amount within the range from 0.5 to 10 parts by weight based on 100 parts by weight of the monomers. When the monomers are not completely compatibilized, a compatibilizing agent (e.g., a water-soluble organic solvent and a low-molecular weight monomer) capable of sufficiently compatibilizing them is preferably added to these monomers. By the addition of the compatibilizing agent, the emulsifiability and copolymerizability can be improved.

Examples of the water-soluble organic solvent include acetone, methyl ethyl ketone, ethyl acetate, propylene glycol, dipropylene glycol monomethyl ether, dipropylene glycol, tripropylene glycol and ethanol. The water-soluble organic solvent may be used in the amount within the range from 1 to 80 parts by weight, e.g., from 5 to 50 parts by weight, based on 100 parts by weight of water.

The copolymer thus obtained can be formed into any form such as an emulsion, an organic solvent solution or an aerosol after optionally diluting with or dispersing in water or an organic solvent, and thus a soil release agent can be obtained. The copolymer functions as an active ingredient of the soil release agent. The soil release agent comprises a fluorine-containing copolymer and a medium (particularly, a liquid medium) (for example, an organic solvent and/or water). In the soil release agent, the concentration of the fluorine-containing copolymer may be, for example, from 0.01 to 50% by weight.

The soil release agent of the present invention preferably comprises a fluorine-containing copolymer and an aqueous medium. As used herein, the term “aqueous medium” means a medium comprising only water, and a medium containing, in addition to water, an organic solvent (the amount of the organic solvent is 80 parts by weight or less, for example, 5 to 50 parts by weight, based on 100 parts by weight of water).

The copolymer of the present invention can be applied by using an optional method to a substrate to be treated, as a soil release agent, according to the type of the treated substrate and the preparation form (an emulsion, an organic solvent solution, or an aerosol). In the case of an aqueous emulsion or an organic solvent solution, a method of coating on the surface of the treated substrate by using a known method, for example, a coating method such as a dip coating or spray coating method, followed by drying can be employed. In this case, a heat treatment such as curing may be performed, if necessary.

If necessary, another blender can be used in combination. Examples of the blender include water- and oil-repellents, anti-wrinkle agents, anti-shrinkage agents, flame retardants, crosslinking agents, antistatic agents, softening agents, water-soluble polymers such as polyethylene glycol and polyvinyl alcohol, wax emulsions, antibacterial agents, pigments, and coating materials. These blenders may be added to a treating bath upon treatment of the substrate. If possible, the blenders may be preliminarily mixed with the copolymer of the present invention.

The substrate to be treated with the surface treatment agent (for example, a water- and oil-repellent agent) of the present invention include a textile, masonry, a filter (for example, an electrostatic filter), a dust protective mask, a part of fuel cell (for example, a gaseous diffusion electrode and a gaseous diffusion support), glass, paper, wood, leather, fur, asbestos, brick, cement, metal and oxide, ceramics, plastics, a coated surface and a plaster. The textile may be particularly a carpet. The textile has various examples. Examples of the textile include animal- or vegetable-origin natural fibers such as cotton, hemp, wool and silk; synthetic fibers such as polyamide, polyester, polyvinyl alcohol, polyacrylonitrile, polyvinyl chloride and polypropylene; semi-synthetic fibers such as rayon and acetate; inorganic fibers such as glass fiber, carbon fiber and asbestos fiber; and a mixture of these fibers. The textile may be in any form such as a fiber, a yarn, a fabric and the like.

In the present invention, a substrate is treated with a soil release agent. The “treatment” means that a treatment agent is applied to a substrate by immersion, spraying, coating or the like. The treatment gives the result that a fluorine-containing polymer which is an active component of the treatment agent is penetrated into the internal parts of the substrate and/or adhered to surfaces of the substrate.

### EXAMPLES

The present invention is now described in detail by way of Examples, Comparative Examples and Test Examples. However, the present invention is not limited to these.

In the following Examples, Comparative Examples and Test Examples, parts and percentages are by weight unless otherwise specified.

Tests were performed in the following manner.

### Soil Release Test

A soil release test was performed in accordance with AATCC Soil Release Management Performance Test Method of the USA. As soils for the test, an artificial oil, which is not easily removed by washing, was prepared and used in place of a cone oil. The artificial oil was prepared by adding 100 ml of Daphne Mechanic Oil (manufactured by Idemitsu Kosan Co., Ltd.) to 1 g of a paste consisting of 16.7% of carbon black, 20.8% of beef tallow superhardened oil and 62.5% of liquid paraffin.

A test cloth having a size of 20 cm×20 cm was spread out on a horizontally spread absorbent blotting paper, and five drops of the artificial oil (about 0.2 cc) as the soil were dropped. A glassine paper was laid thereon and a weight of 2,268 g was placed, followed by standing for 60 seconds. After 60 seconds, the weight and the glassine paper were removed, followed by standing at room temperature for 15 minutes. After the lapse of 15 minutes, the test cloth and a ballast cloth (total weight: 1.8 kg) were washed under the conditions of a bath volume of 64 liters and a bath temperature of 38° C. for 12 minutes using 100 g of a detergent (an AATCC standard WOB detergent) and an AATCC standard washing machine (manufactured by Kenmore, USA). The clothes were rinsed and then dried by using an AATCC standard tumbler drying machine (manufactured by Kenmore, USA). The state of the remaining soil on the dried test cloth was compared with that of a standard photographic plate for criterion and expressed by the corresponding criteria class (cf. Table 1). As the standard photographic plate for criterion, a photographic plate of AATCC-TM130-2000 (American Association of Textile Chemists and Colorists Test Method 130-2000) was used.

TABLE 1
Criteria class of soil releasability

| Class | Criterion |
|---|---|
| 1.0 | Remarkable soil remained |
| 2.0 | Considerable soil remained |
| 3.0 | Slight soil remained |
| 4.0 | Little soil remained |
| 5.0 | No soil remained |

An oil repellency test was performed in accordance with AATCC-TM118-2000 using a textile. A test cloth was spread out and several drops of a test liquid shown in Table 2 were dropped. It was evaluated by the state of the test liquid which passes the test cloth after 30 seconds. In the case of low oil repellency, an oil soil intrudes into an article to be treated, thus making it difficult to remove the oil soil. Therefore, oil repellency is an important evaluation indicator, similar to a test of soil releasability (SR properties).

TABLE 2
Criteria class of oil repellency

| Oil | | Surface tension |
|---|---|---|
| repellency | Test solution | (dyne/cm, 25° C.) |
| 8 | n-heptane | 20.0 |
| 7 | n-octane | 21.8 |
| 6 | n-decane | 23.5 |
| 5 | n-dodecane | 25.0 |
| 4 | n-tetradecane | 26.7 |
| 3 | n-hexadecane | 27.3 |
| 2 | Mixed liquid of | 29.6 |
| | hexadecane/Nujor (35/65) | |
| 1 | Nujor | 31.2 |
| 0 | Inferior to 1 | — |

### Synthesis Example 1

### 9FSO2PA Monomer

### Synthesis of 3-(perfluorobutylsulfonyl)propyl acrylate

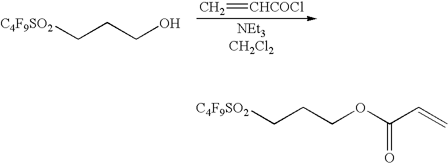

A solution of 3-(perfluorobutylsulfonyl)propanol (54.4 g, 159 mmol), triethylamine (33 ml, 238 mmol), 4-t-butylcatechol (0.14 g) and dichloromethane (520 ml) was cooled to 0° C. in an equipment having a calcium chloride tube, and then acryloyl chloride (15.5 ml, 191 mmol) was slowly added dropwise over 40 minutes. After stirring at room temperature for one hour and washing the mixture with a 15% aqueous citric acid solution (600 ml) and a saturated saline solution, the mixture was dried over anhydrous magnesium sulfate, filtered and then concentrated under reduced pressure to give a crude acrylate ester. The residue was purified by silica gel column chromatography (n-hexane:ethyl acetate=6:1) and the concentrated transparent liquid was vacuum-dried to obtain 60.0 g of 3-(perfluorobutylsulfonyl)-propyl acrylate. Yield was 95.3%.

¹H NMR (CDCl₃; internal standard TMS δ ppm): 6.45 (dd, 1H, J_{AB}=1.1 Hz, J_{AX}=17.3 Hz, CH_{A}H_{B}═C), 6.12 (dd, 1H, J_{AX}=17.3 Hz, J_{BX}=10.5 Hz, C═CH_{X}), 5.95 (dd, 1H, J_{BX}=10.5 Hz, J_{AB}=1.1 Hz, CH_{A}H_{B}═C), 4.34 (t, 2H, J_{HH}=6.0 Hz, OCH₂), 3.41 (t, 2H, J_{HH}=7.8 Hz, CH₂SO₂), 2.36 (tt, 2H, J_{HH}=7.8 Hz, J_{HH}=6.0 Hz, CH₂CH₂CH₂).

¹⁹F NMR (CDCl₃; internal standard CFCl₃ δ ppm): −81.2 (m, 3F, CF₃), −113.8 (m, 2F, CF₂SO₂), −121.8 (m, 2F, CF₂), −126.3 (m, 2F, CF₂).

### Synthesis Example 2

### Step 1

### Synthesis of 2-(3,3,4,4,5,5,6,6,6-nonafluorohexylthio)ethyl acrylate

### 9FES2EA Monomer

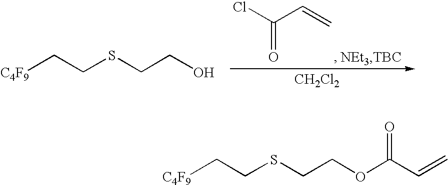

A solution of 2-(3,3,4,4,5,5,6,6,6-nonafluorohexylthio)ethanol (81 g, 250 mmol), triethylamine (52.3 ml, 375 mmol), 4-t-butyl catechol (1 particle) and dichloromethane (500 ml) was cooled to 0° C., and then acryloyl chloride (24.4 ml, 300 mmol) was slowly added dropwise over 10 minutes. After stirring at room temperature (23° C.) for 40 minutes and washing the mixture with 500 ml of a 5% aqueous citric acid solution and a saturated saline solution, the mixture was dried over anhydrous magnesium sulfate and then filtered to obtain 81.0 g of a crude acrylate ester. Yield was 85.7%.

### Step 2

### Synthesis of 2-(3,3,4,4,5,5,6,6,6-nonafluorohexylsulfonyl)ethyl acrylate

### 9FESO2EA Monomer

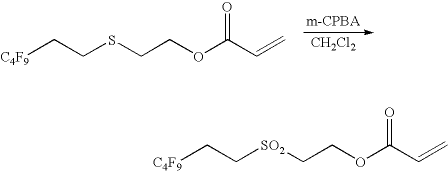

A solution of the crude 2-(3,3,4,4,5,5,6,6,6-nonafluorohexylthio)ethyl acrylate (81.0 g, 214 mmol) thus obtained in dichloromethane (1.5 liters) was ice-cooled, and then m-chloroperbenzoic acid (100 g, 446 mmol) was gradually added. After the completion of addition, the mixture was stirred at room temperature (23° C.) overnight, filtered and the filtrate was washed with an aqueous 30% sodium thiosulfate pentahydrate solution. After disappearance of peroxy acid in the aqueous layer was confirmed by a iodine-starch reaction, the organic layer was washed with saturated sodium bicarbonate water. The organic layer was dried over magnesium sulfate and filtered. The filtrate was concentrated under reduced pressure and the residue was purified by silica gel column chromatography (n-hexane:ethyl acetate=5:1), and then the white solid after concentration was dried to obtain 55.4 g of a sulfone compound. Yield was 63.1%.

¹H NMR (CDCl₃; internal standard TMS δ ppm): 6.45 (dd, 1H, J_{AB}=1.1 Hz, J_{AX}=17.3 Hz, CH_{A}H_{B}═C), 6.12 (dd, 1H, J_{AX}=17.3 Hz, J_{BX}=10.5 Hz, C═CH_{X}), 5.95 (dd, 1H, J_{BX}=10.5 Hz, J_{AB}=1.1 Hz, CH_{A}H_{B}═C), 4.65 (t, 2H, J_{HH}=5.6 Hz, OCH₂), 3.42 (t, 2H, J_{HH}=5.7 Hz, CH₂SO₂), 3.33 (tt, 2H, J_{HH}=8.5 Hz, SO₂CH₂CH₂CF₂), 2.69 (m, 2H, CH₂CF₂)

¹⁹F NMR (CDCl₃; internal standard CFCl₃ δ ppm): −81.5 (t, 3F, J=9.3 Hz, CF₃), −114.4 (m, 2F, CF₂), −124.6 (m, 2F, CF₂), −126.5 (m, 2F, CF₂).

A copolymer was produced in the following manner.

### Example 1

In a 100 ml four-necked flask, the monomer (9FS02PA monomer) (7.0 g) synthesized in Synthesis Example 1, methoxypolyethylene glycol methacrylate (EO 9 mol) (M-90G) (2.0 g), 2-hydroxyethyl methacrylate (HEMA) (0.8 g), 2-methacryloyloxyethyltrimethylammonium chloride (DQ-100) (0.2 g), 2-mercaptoethanol (0.02 g) and dipropylene glycol monomethyl ether (29 g) were charged and nitrogen flow was performed for 60 minutes. After the inner temperature was raised to 75-80° C., azobisisobutyronitrile (0.1 g) dissolved in methyl ethyl ketone (1 g) was added and the reaction was performed for 8 hours. The molecular weight of the resulting polymerization liquid was measured by gel permeation chromatography. The measurement revealed that a peak derived from the monomer approximately disappeared and a peak derived from the copolymer was generated. The weight-average molecular weight of the copolymer was 11,000 (in terms of polystyrene).

### Example 2

The same polymerization and analysis as in Example 1 were performed except replacing methoxypolyethylene glycol methacrylate (EO 9 mol) in Example 1 by methoxypolyethylene glycol methacrylate (EO 23 mol) (M-230G). The ingredients and the weight-average molecular weight of the copolymer are shown in Table 3.

### Examples 3 to 11

Copolymer solutions were obtained by repeating the same procedure as in Example 1 except using the types and weight ratios of the monomers shown in Table 3. The ingredients and the weight-average molecular weights of the copolymers are shown in Table 3.

### Example 12

The same polymerization and analysis as in Example 1 were performed except replacing the 9FSO2PA monomer in Example 1 by the 9FESO2EA monomer synthesized in Synthesis Example 2. The ingredients and the weight-average molecular weight of the copolymer are shown in Table 3.

### Examples 13 to 14

Copolymer solutions were obtained by repeating the same procedure as in Example 1 except using the types and weight ratios of the monomers shown in Table 3. The ingredients and the weight-average molecular weights of the copolymers are shown in Table 3.

### Comparative Example 1

In a 100 ml four-necked flask, 7.0 g of 2-(perfluorobutyl)ethyl acrylate, 2.0 g of methoxypolyethylene glycol methacrylate (EO 9 mol), 0.8 g of 2-hydroxyethyl methacrylate, 0.2 g of 2-methacryloyloxyethyltrimethylammonium chloride, 0.02 g of 2-mercaptoethanol and 29 g of dipropylene glycol monomethyl ether were charged and nitrogen flow was performed for 60 minutes. After the inner temperature was raised to 75-80° C., 0.1 g of azobisisobutyronitrile dissolved in 1 g of methyl ethyl ketone was added and the reaction was performed for 8 hours. The molecular weight of the resulting polymerization liquid was measured by gel permeation chromatography. The measurement revealed that a peak derived from the monomer approximately disappeared and a peak derived from the copolymer was generated. The weight-average molecular weight of the copolymer was 12,000 (in terms of polystyrene).

### Comparative Examples 2 to 7

Copolymer solutions were obtained by repeating the same procedure as in Example 1 except using the types and weight ratios of the monomers shown in Table 3. The ingredients and the weight-average molecular weights of the copolymers are shown in Table 3.

### Test Example 1

The polymer solution obtained in Example 1 was diluted with water to prepare an aqueous dispersion having a copolymer content of 0.86% by weight. In this case, stearyltrimethylammonium chloride was added in the amount of 1.5% by weight based on the polymer for the purpose of facilitating dispersion. A cotton twill cloth and a mixed twill cloth of 65% polyester and 35% cotton were immersed in the treatment solution thus obtained, and then squeezed with a roll, thereby adjusting wet pickup to 60% by weight and 55% by weight, respectively. The cloths were dried at 110° C. for 2 minutes and then heat-treated at 160° C. for 2 minutes, thereby completing a soil releasing treatment. Soil releasability and oil repellency of these cloths were measured. The results are shown in Table 5.

For the purpose of evaluating washing durability, the treated cloths were washed at a bath temperature of 40° C. for 25 minutes using a washing machine, and then tumbler-dried. Soil releasability and oil repellency of the treated cloths were measured in the same manner as described above. The results are shown in Table 5.

### Test Examples 2 to 14 and Comparative Test Examples 1 to 7

Treatment solutions were prepared by the same procedure as in Test Example 1, except that the polymer solution was replaced by each of polymer solutions obtained in Examples 2 to 14 and Comparative Examples 1 to 7, and the cloths were treated and then soil releasability and oil repellency were measured.

The results are shown in Table 5.

TABLE 3

| | | | Weight-average |
|---|---|---|---|
| | | | molecular |
| | | Monomer weight | weight of |
| | Monomer ingredients | ratio (%) | polymer |
| Example 1 | 9FSO2PA/M-90G/HEMA/DQ-100 | 70/20/8/2 | 9,000 |
| Example 2 | 9FSO2PA/M-230G/HEMA/DQ-100 | 70/20/8/2 | 12,000 |
| Example 3 | 9FSO2PA/AE-400/HEMA/DQ-100 | 70/20/8/2 | 11,000 |
| Example 4 | 9FSO2PA/PE-200/HEMA/DQ-100 | 70/20/8/2 | 12,000 |
| Example 5 | 9FSO2PA/PE-350/HEMA/DQ-100 | 70/20/8/2 | 9,000 |
| Example 6 | 9FSO2PA/M-90G/GLM | 70/20/10 | 29,000 |
| Example 7 | 9FSO2PA/M-90G/HO-MS | 70/20/10 | 29,000 |
| Example 8 | 9FSO2PA/M-90G/DMAEM acetic acid | 70/20/10 | 8,000 |
| | neutral salt | | |
| Example 9 | 9FSO2PA/M-90G/HEMA | 70/20/10 | 24,000 |
| Example 10 | 9FSO2PA/M-90G/TM/GLM | 65/25/7/3 | 50,000 |
| Example 11 | 9FSO2PA/M-90G/TM/PP-800/GLM | 70/20/5/3/2 | 19,000 |
| Example 12 | 9FESO2EA/M-90G/HEMA/DQ-100 | 70/20/8/2 | 12,000 |
| Example 13 | 9FESO2EA/M-230G/HEMA/DQ-100 | 70/20/8/2 | 15,000 |
| Example 14 | 9FSO2PA/70PEP-350B/HEMA/DQ-100 | 70/20/8/2 | 12,000 |
| Comparative | 9FA/M-90G/HEMA/DQ-100 | 70/20/8/2 | 12,000 |
| Example 1 | | | |
| Comparative | 9FMA/M-90G/HEMA/DQ-100 | 70/20/8/2 | 7,000 |
| Example 2 | | | |
| Comparative | 9FClA/M-230G/HEMA/DQ-100 | 65/25/5/5 | 5,000 |
| Example 3 | | | |
| Comparative | 9FMA/M-90G/PP-800/GLM/TM | 56/22.6/10.7/ | 125,000 |
| Example 4 | | 2.7/8 | |
| Comparative | 19FA/M-90G/PP-800/HEMA | 56/26/8/10 | 30,000 |
| Example 5 | | | |
| Comparative | 9FMA/70PEP-350B/HEMA/DQ-100 | 70/20/8/2 | 11,000 |
| Example 6 | | | |
| Comparative | 9FMA/M-90G/GLM/TM | 60/29.3/2.7/8 | 65,000 |
| Example 7 | | | |

TABLE 4
(Explanation of abbreviation in Table 3)

| | Trade name | Chemical name | Manufacturer |
|---|---|---|---|
| M-90G | NK ESTER M-90G | Methoxypolyethylene glycol methacrylate (EO 9 mol) | Shin-nakamura Chemical Co., Ltd. |
| M-230G | NK ESTER M-230G | Methoxypolyethylene glycol methacrylate (EO 23 mol) | Shin-nakamura Chemical Co., Ltd. |
| TM | TOPOLENE M | 3-chloro-2-hydroxypropyl methacrylate | Shin-nakamura Chemical Co., Ltd. |
| DQ-100 | LIGHT-ESTER DQ-100 | 2-methacryloyloxyethyltrimethylammonium chloride | Kyoeisha Chemical Co., Ltd. |
| DMAEM | LIGHT-ESTER DM | Dimethylaminoethyl methacrylate | Kyoeisha Chemical Co., Ltd. |
| HO-MS | LIGHT-ESTER HO-MS | 2-methacryloyloxyethylsuccinic acid | Kyoeisha Chemical Co., Ltd. |
| HEMA | | 2-hydroxyethyl methacrylate | |
| GLM | BLEMMER GLM | Glycerol monomethacrylate | NOF Corporation |
| AE-400 | BLEMMER AE-400 | Polyethylene glycol monoacrylate (EO 10 mol) | NOF Corporation |
| PE-200 | BLEMMER PE-200 | Polyethylene glycol monomethacrylate (EO 4.5 mol) | NOF Corporation |
| PE-350 | BLEMMER PE-350 | Polyethylene glycol monomethacrylate (EO 8 mol) | NOF Corporation |
| PP-800 | BLEMMER PP-800 | Polypropylene glycol monomethacrylate (PO 13 mol) | NOF Corporation |
| 70PEP- | BLEMMER 70PEP- | Polyethylene glycol polypropylene glycol | NOF Corporation |
| 350B | 350B | monomethacrylate (EO 5, PO 2) | |
| 9FA | | 2-(perfluorobutyl)ethyl acrylate | |
| 9FMA | | 2-(perfluorobutyl)ethyl methacrylate | |
| 9FSO2PA | | 2-(perfluorobutylsulfonyl)propyl acrylate | |
| 9FESO2EA | | 2-(3,3,4,4,5,5,6,6,6-nonafluorohexylsulfonyl)ethyl | |
| | | acrylate | |
| 9FClA | | 2-(perfluorobutyl)ethyl 2-chloroacrylate | |
| 19FA | | 2-(perfluorooctyl)ethyl acrylate | |

TABLE 5

| | Oil repellency | | | | SR properties (artificial oil) | | | |
|---|---|---|---|---|---|---|---|---|
| | PET/Co twill | | Co beige | | PET/Co twill | | | Co beige |
| | | After | | After | | After | | After |
| | Initial | washing | Initial | washing | Initial | washing | Initial | washing |
| Example 1 | 6 | 5 | 5 | 4 | 4 | 4 | 4 | 4 |
| Example 2 | 6 | 5 | 5 | 5 | 4 | 3-4 | 4 | 4 |
| Example 3 | 6 | 6 | 5 | 5 | 4 | 3-4 | 4 | 4 |
| Example 4 | 6 | 5 | 5 | 4 | 3-4 | 3-4 | 4 | 4 |
| Example 5 | 6 | 5 | 5 | 5 | 4 | 3-4 | 4 | 4 |
| Example 6 | 5 | 5 | 4 | 2 | 4 | 3 | 3 | 3 |
| Example 7 | 6 | 5 | 4 | 2 | 4 | 3 | 3 | 3 |
| Example 8 | 5 | 2 | 4 | 3 | 3 | 2-3 | 4 | 4 |
| Example 9 | 6 | 6 | 5 | 2 | 4 | 3 | 4 | 4 |
| Example 10 | 6 | 6 | 4 | 4 | 4 | 3-4 | 4 | 4 |
| Example 11 | 6 | 6 | 4 | 5 | 3 | 3 | 3 | 4 |
| Example 12 | 6 | 4 | 3 | 2 | 4 | 3-4 | 4 | 3-4 |
| Example 13 | 6 | 4 | 3 | 2 | 4 | 3-4 | 3-4 | 3-4 |
| Example 14 | 6 | 6 | 6 | 6 | 4 | 4 | 4 | 4 |
| Comparative | 2 | 2 | 2 | 2 | 3 | 3 | 3 | 3 |
| Example 1 | | | | | | | | |
| Comparative | 5 | 3 | 3 | 2 | 3 | 2-3 | 3 | 3 |
| Example 2 | | | | | | | | |
| Comparative | 4 | 0 | 4 | 1 | 2-3 | 2 | 2 | 2 |
| Example 3 | | | | | | | | |
| Comparative | 3 | 0 | 2 | 1 | 2 | 2-3 | 2 | 2 |
| Example 4 | | | | | | | | |
| Comparative | 6 | 5 | 5 | 1 | 4 | 4 | 3 | 3 |
| Example 5 | | | | | | | | |
| Comparative | 4 | 2 | 3 | 2 | 3 | 2 | 3 | 3 |
| Example 6 | | | | | | | | |
| Comparative | 2 | 0 | 2 | 0 | 2-3 | 2-3 | 2 | 2-3 |
| Example 7 | | | | | | | | |
| Non-treated cloth | 0 | 0 | 0 | 0 | 1 | 1 | 2 | 2 |

Note)
The number A-number B in the table means an intermediate performance between A and B.

1. A fluorine-containing copolymer comprising:
(a) a fluorine-containing monomer represented by the general formula:
CH₂═C(—X)—C(═O)—Y—[—(CH₂)ₘ-Z-]ₚ-(CH₂)ₙ—Rf (1)
wherein X represents a hydrogen atom, a linear or branched alkyl group having 1 to 21 carbon atoms, a fluorine atom, a chlorine atom, a bromine atom, a iodine atom, a CFX¹X² group (wherein X and X² represent a hydrogen atom, a fluorine atom, a chlorine atom, a bromine atom, or a iodine atom), a cyano group, a linear or branched fluoroalkyl group having 1 to 21 carbon atoms, a substituted or an unsubstituted benzyl group, or a substituted or an unsubstituted phenyl group;
Y represents —O— or —NH—;
Z represents —S— or —SO₂—;
Rf represents a fluoroalkyl group having 1 to 21 carbon atoms;
m represents 1 to 10, n represents 0 to 10, and p represents 0 or 1; and
(b) a polyalkylene glycol (meth)acrylate.

2. The fluorine-containing copolymer according to claim 1, wherein the fluoroalkyl group (Rf group) is a perfluoroalkyl group having 1 to 6 carbon atoms.

3. The fluorine-containing copolymer according to claim 1, wherein the fluorine-containing monomer (a) is represented by the general formula:
CH₂═C(—X)—C(═O)—O—(CH₂)ₘ—SO₂—(CH₂)ₙ—Rf (2)
wherein X represents a hydrogen atom or a methyl group;
Rf represents a fluoroalkyl group having 1 to 21 carbon atoms; and
m represents 1 to 10, and n represents 0 to 10.

4. The fluorine-containing copolymer according to claim 1, wherein the component (b) is represented by the general formula:
CH₂═CX¹C(═O)—O—(RO)ₙ—X² (3a)
and/or
CH₂═CX¹C(═O)—O—(RO)ₙ—C(═O)CX¹═CH₂ (3b)
wherein
X¹ is a hydrogen atom or a methyl group,
X² is a hydrogen atom or an unsaturated or saturated hydrocarbon group having 1 to 22 carbon atoms,
R is an alkylene group having 2 to 6 carbon atoms, and
n is an integer of 2 to 90.

5. The fluorine-containing copolymer according to claim 1, wherein an amount of the component (a) is from 20 to 90% by weight and an amount of the component (b) is from 10 to 80% by weight based on the total of the component (a) and the component (b) in the fluorine-containing copolymer.

6. The fluorine-containing copolymer according to claim 1, wherein a number-average molecular weight of the fluorine-containing copolymer is from 1,000 to 1,000,000.

7. A soil release agent comprising the fluorine-containing copolymer according to claim 1.

8. A soil release agent composition comprising the fluorine-containing copolymer according to claim 1, and an aqueous medium.

9. A method for treating a substrate, which comprises treating the substrate with the soil release agent according to claim 7.

10. A textile treated with the soil release agent according to claim 7.
